(19) United States
(12) Patent Application Publication
(10) Pub. No.: US 2026/0070331 A1
(43) Pub. Date: Mar. 12, 2026

(54) LIQUID EJECTION HEAD AND LIQUID EJECTION APPARATUS

(71) Applicant: CANON KABUSHIKI KAISHA, Tokyo (JP)

(72) Inventors: AYAKO IWASAKI, Kanagawa (JP); YOSHIYUKI NAKAGAWA, Kanagawa (JP); TAKASHI KATO, Kanagawa (JP)

(21) Appl. No.: 19/324,722

(22) Filed: Sep. 10, 2025

(30) Foreign Application Priority Data
Sep. 11, 2024 (JP) 2024-157588

(51) Int. Cl. B41J 2/045; B41J 2/14

(52) U.S. Cl. CPC B41J 2/04573; B41J 2/0458; B41J 2/1404; B41J 2/1433; B41J 2202/12

(57) ABSTRACT

Provided is a liquid ejection had including: a liquid ejection portion which includes a pressure chamber, an ejection nozzle for ejecting liquid from the pressure chamber, and an energy generating element that generates energy to eject liquid from the ejection nozzle; a circulation flow passage which includes an inflow port to which liquid flows in, and an outflow port from which liquid flows out, with the pressure chamber being disposed between the inflow port and the outflow port. The liquid ejection head further includes: a first thermoelectric conversion element which is disposed on the circulation flow passage on a side closer to the inflow port than the energy generating element; and a second thermoelectric conversion element which is disposed on the circulation flow passage, and which is disposed adjacent to the first thermoelectric conversion element. The first and second thermoelectric conversion elements are driven at timings different from each other.

### BACKGROUND

### Field of the Technology

The present disclosure relates to a liquid ejection head and a liquid ejection apparatus.

### Description of the Related Art

In the case of a liquid ejection head, such as an inkjet recording head, the thickening of ink (liquid) is one factor that deteriorates image quality. At an ejection nozzle where the ejection of ink has not been performed for a while, ink evaporates from the ejection nozzle, whereby ink thickens. Variations in the ejection amount and the ejection direction of each ejection nozzle can cause streaks and uneven density to appear in an image, resulting in poor image quality.

To prevent the thickening of ink described above, a mechanism to circulate ink in a liquid ejection head has been proposed recently. By circulating ink, the thickened ink near the ejection nozzle is pushed away, and fresh ink can be supplied. Japanese Patent Application Publication No. 2020-104312 discloses a configuration where one energy generating element to eject liquid (energy generating element for ejection), and one thermoelectric conversion element to send liquid inside a circulation flow passage including a pressure chamber (energy generating element for circulation), are disposed consecutively in the circulation flow passage.

In Japanese Patent Application Publication No. 2020-104312, the energy generating element for ejection and the energy generating element for circulation are disposed one-to-one, and as the flow passage width narrows because of the increase in the density of the ejection nozzles, the pump size is restricted. Further, in a case where the energy generating element for circulation is driven at high frequency to increase the flow rate and the energy generating element for circulation is a thermoelectric conversion element, re-boiling is caused by local heating, a foaming failure is generated, and the flow rate of the pump decreases thereby. This means that the frequency to drive the energy generating element for circulation is restricted, and the flow rate is also restricted accordingly, hence the thickening of ink at the ejection nozzle may not be resolved.

### SUMMARY

The present disclosure is directed to provide a technique to improve the circulation efficiency in a liquid ejection head having a configuration to circulate liquid using an energy generating element.

To solve the above problem, a liquid ejection head of the present disclosure includes:

a liquid ejection portion which includes a pressure chamber, an ejection nozzle for ejecting liquid from the pressure chamber, and an energy generating element that generates energy to eject liquid inside the pressure chamber from the ejection nozzle;

a circulation flow passage which includes an inflow port to which liquid to be supplied to the pressure chamber flows in, and an outflow port from which liquid collected from the pressure chamber flows out, with the pressure chamber being disposed between the inflow port and the outflow port,

a first thermoelectric conversion element which is disposed on the circulation flow passage on a side closer to the inflow port than the energy generating element; and

a second thermoelectric conversion element which is disposed on the circulation flow passage on a side closer to the inflow port than the energy generating element, and which is disposed adjacent to the first thermoelectric conversion element, wherein

the first thermoelectric conversion element and the second thermoelectric conversion element are driven at timings different from each other.

Features of the present disclosure will become apparent from the following description of embodiments with reference to the attached drawings. The following description of embodiments is described by way of example.

### BRIEF DESCRIPTION OF THE DRAWINGS

FIG. 1 is an oblique view of an inkjet recording head.

FIG. 2 is a perspective view of a recording element substrate of a comparative example from a side facing the ejection nozzles.

FIG. 3A is a schematic perspective view of a U-type flow passage configuration in a recording element substrate of Embodiment 1, when the recording element substrate of a liquid ejection head is viewed from the side facing the ejection nozzles.

FIG. 3B is a cross-section view of FIG. 3A from the arrow A direction.

FIG. 3C is a cross-sectional view of FIG. 3A from the arrow B direction.

FIG. 4 is a perspective view of a recording element substrate of a modification of Embodiment 1 from a side facing the ejection nozzles.

FIG. 5A is a schematic diagram depicting a timing of a driving signal of a voltage pulse that is applied to the energy generating element in a case of driving only a first thermoelectric conversion element of a comparative example.

FIG. 5B is a schematic diagram depicting a timing of a driving signal of a voltage pulse that is applied to the energy generating element in a case of driving only the first thermoelectric conversion element of the comparative example at a driving frequency higher than FIG. 5A.

FIG. 5C is a schematic diagram depicting driving signals applied to a first thermoelectric conversion element and a second thermoelectric conversion element of Embodiment 1.

FIG. 6A is a perspective view of a part of flow passages near the ejection nozzles of a recording element substrate of Embodiment 2 from a side facing the ejection nozzles.

FIG. 6B is schematic diagrams of a driving signal indicating a driving timing of a voltage pulse that is applied to three thermoelectric conversion elements.

FIG. 7A is a perspective view of a configuration from an orifice plate to a first flow passage member when a recording element substrate of Embodiment 3 is viewed from the side facing the ejection nozzles.

FIG. 7B is a perspective view of a configuration from a first substrate to a second substrate when the recording element substrate of Embodiment 3 is viewed from the side facing the ejection nozzles.

FIG. 7C is a cross-sectional view of FIG. 7A and FIG. 7B from the arrow D direction.

FIG. 8A is a perspective view of a recording element substrate of Embodiment 4 from a side facing the ejection nozzles.

FIG. 8B is a cross-sectional view of FIG. 8A from the arrow C direction.

FIG. 8C is a cross-sectional view in a case where a supply side common flow passage and a discharge side common flow passage, penetrating a second flow passage member layered on the first substrate, are formed.

FIG. 9 is a diagram for describing a recording element substrate of Embodiment 5.

FIG. 10 is a diagram for describing a driving signal of a thermoelectric conversion element of Embodiment 6.

FIG. 11 is a block diagram depicting a control configuration of a liquid ejection apparatus.

### DESCRIPTION OF THE EMBODIMENTS

Embodiments of the present disclosure will be described in detail based on examples with reference to the drawings. Dimensions, materials, shapes, relative positions and the like of the composing elements described in the embodiments may be appropriately changed in accordance with the configuration and various conditions of an apparatus to which the disclosure is applied. In other words, the following embodiments are not intended to restrict the scope of the present disclosure.

In the following embodiments, a plurality of features are described, but not all of the plurality of features are essential to implement the disclosure, and the plurality of features may be combined freely. Further, in the accompanying drawings, same or similar composing elements are denoted with a same reference number among the embodiments, and redundant description thereof is omitted.

### Embodiment 1

### Description on Head Configuration

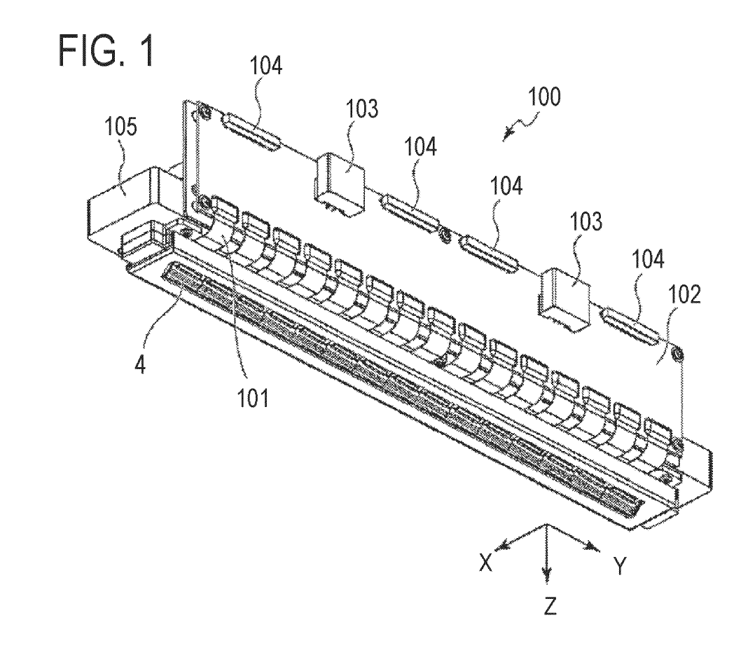

FIG. 1 is an oblique view of an inkjet recording head 100 (hereafter also called “recording head”), which can be used as the liquid ejection head of the present disclosure. The recording head 100 according to Embodiment 1 of the present disclosure is used as a liquid ejection apparatus which is installed in a recording apparatus based on an inkjet recording system. For example, the recording apparatus causes the recording head 100 to eject a plurality of colors of liquid selectively, and allows the liquid to deposit on a recording medium, whereby characters, symbols, images and the like are formed (recorded). For the recording medium, any medium may be used as long as an image can be formed by depositing liquid droplets. For example, various materials and formats of recording media may be used, such as paper, cloth, optical disk label surface, plastic sheet, OHP sheet and envelope. A typical example of the liquid ejected by the liquid ejection head to which the present disclosure is applicable is ink, but the liquid is not limited to ink, and may be a reaction solution or a pre-treatment solution which is replenished to the liquid ejection apparatus. In the recording head 100, a plurality of recording element substrates 4, in which a plurality of recording elements are disposed in the Y direction, are arrayed in the Y direction. Here a full line type recording head 100 is illustrated, where the recording element substrates 4 are arrayed in the Y direction for a distance corresponding to an A4 size width.

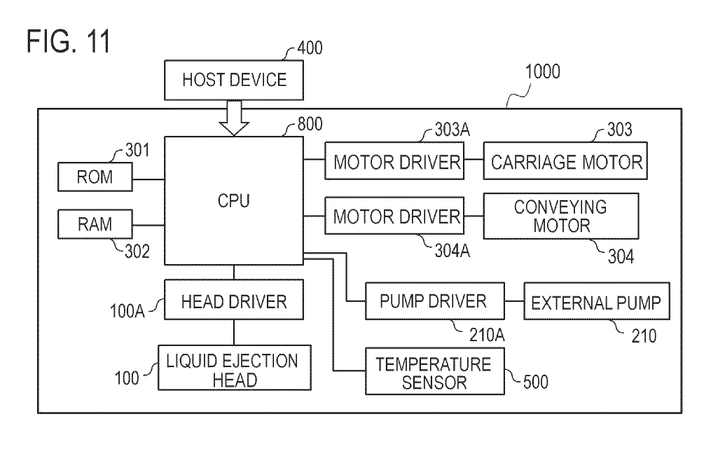

Each of the recording element substrates 4 is connected to a same electric wiring board 102 via a flexible wiring board 101. On the electric wiring board 102, power supply terminals 103 to receive power and signal input terminals 104 to receive ejection signals transmitted from a CPU 800 (see FIG. 11), which is a control portion, are disposed. In an ink supply unit 105, circulation flow passages are formed to supply ink, received from an ink tank (not illustrated), to each recording element substrate 4, or to collect ink which was not consumed during recording.

In the above configuration, each of the recording elements disposed on the recording element substrate 4 ejects ink (supplied by the ink supply unit 105) in the Z direction in FIG. 1, using power (supplied from a power supply terminal 103) based on the ejection signal inputted through the input terminal 104.

FIG. 11 is a block diagram depicting a control system of a recording apparatus 1000, for which the recording head 100 of Embodiment 1 is used. The CPU 800 is a control portion which controls each unit of the recording apparatus 1000 based on programs (e.g. processing procedure) stored in a ROM 301. A RAM 302 is used as a work area and the like when the CPU 800 executes processing. The CPU 800 receives image data from a host device 400 outside the recording apparatus 1000, and controls the driving of elements disposed in the recording head 100 by controlling a head driver 100A based on the image data. The CPU 800 receives information on temperature detected by a temperature sensor 500. The CPU 800 controls the driving of various energy generating elements (thermos-electric conversion elements) of the recording head 100 using the head driver 100A.

The CPU 800 also controls the drivers of various actuators disposed in the recording apparatus 1000. For example, the CPU 800 controls a motor driver 303A of the carriage motor 303 to move a carriage holding the recording head 100. The CPU 800 also controls a motor driver 304A of a conveying motor 304 to convey a recording medium, and controls a pump driver 210A of an external pump 210. FIG. 11 indicates processing performed when image data is received from the host device 400, but it is also possible to perform processing on the recording apparatus 1000 without relying on data from the host device 400.

### Description of Recording Element

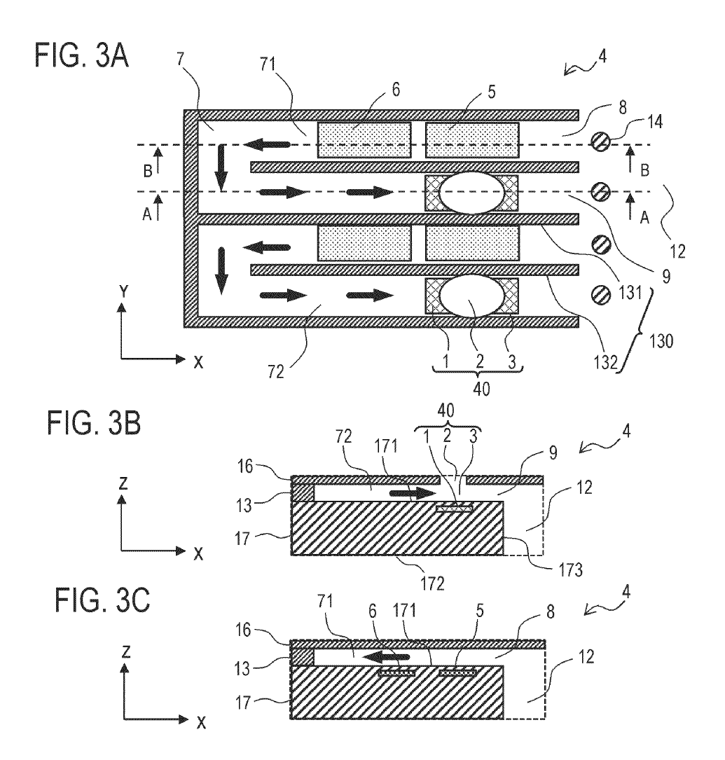

FIGS. 3A to 3C are schematic diagrams enlarging a part of the recording element substrate 4 of the recording head 100 illustrated in FIG. 1, and indicate a part of the flow passages near the ejection nozzles according to Embodiment 1. FIG. 3A is a schematic perspective view of a U-type flow passage configuration when the recording element substrate 4 of a liquid ejection head is viewed from the side facing the ejection nozzles (in the -Z direction). FIG. 3B is a cross-sectional view of FIG. 3A from the arrow A direction. FIG. 3C is a cross-sectional view of FIG. 3A from the arrow B direction.

First the layout configuration of each unit of the recording head 100 according to Embodiment 1 will be described. Here in Embodiment 1, to specify the layout of each unit of the recording head 100, a first direction, a second direction and a third direction are assumed to be a Z direction, an X direction and Y direction respectively, and the three directions intersect orthogonally with each other, but the configuration of the present invention is not limited to this. For example, in a range where the functions and the like of the recording head 100 are not affected, the three directions may cross each other, inclining slightly from the Z direction, the X direction and the Y direction respectively.

As a configuration to form an ink ejection portion 40 (liquid ejection portion), the recording element substrate 4, constituting the recording head 100 according to Embodiment 1, includes a pressure chamber 3, an ejection nozzle 2 and an energy generating element 1, which generates energy to eject ink inside the pressure chamber from the ejection nozzle 2. The energy generating element 1 is configured by a thermoelectric conversion element in Embodiment 1. The energy generating element 1 is not limited to the thermoelectric conversion element, but may be a piezoelectric element or the like. This ink ejection portion 40 is disposed on the circulation flow passage 7. The circulation flow passage 7 includes an inflow port 8 (supply flow passage) through which ink to be supplied to the ink ejection portion 40 flows in, and an outflow port 9 (discharging flow passage) through which ink collected from the ink ejection portion 40 flows out. The ink ejection portion 40 is disposed on the circulation flow passage 7, between the inflow port 8 and the outflow port 9.

The recording element substrate 4 further includes a first thermoelectric conversion element 5 and a second thermoelectric conversion element 6, as energy generating elements which generate energy to flow ink inside the circulation flow passages. The first thermoelectric conversion element 5 is disposed on the side closer to the inflow port 8, than to the energy generating element 1 on the circulation flow passage 7, and the second thermoelectric conversion element 6 is disposed on the side closer to the inflow port 8, than to the energy generating element 1 on the circulation flow passage 7, at a position adjacent to the first thermoelectric conversion element 5. In Embodiment 1, on the circulation flow passage 7, the second thermoelectric conversion element 6 is disposed on a side more distant from the inflow port 8, than from the first thermoelectric conversion element 5.

The circulation flow passage 7 is an approximately U-shaped flow passage in its entirety, as illustrated in FIG. 3A. The inflow port 8 and the outflow port 9 are disposed on one side of the ink ejection portion 40, in the X direction (second direction), which crosses with the Z direction (first direction), that is, the direction where the ejection nozzle 2 opens (ink ejection position). Further, the inflow port 8 and the outflow port 9 are disposed in a line in the Y direction (third direction), which crosses with both the Z direction (first direction) and the X direction (second direction). The circulation flow passage 7 includes an upstream side flow passage 71, which extends from the inflow port 8 (from one side to the other side in the X direction), and a downstream side flow passage 72, which extends from the upstream side flow passage 71 by turning to the opposite direction (from the other side to the one side in the X direction). The first thermoelectric conversion element 5 and the second thermoelectric conversion element 6 are disposed on the upstream side flow passage 71, and the ink ejection portion 40 is disposed on the downstream side flow passage 72.

As illustrated in FIG. 3B, the recording element substrate 4 of Embodiment 1 is configured such that a first substrate 17, a first flow passage member 13 (first flow passage forming member), and an orifice plate 16 are sequentially layered in the Z direction. On the surface of the first substrate 17 in the cross-sectional view from the arrow A direction, the energy generating element 1 (thermoelectric conversion element) is disposed, and an ejection nozzle 2 is formed at the position of the orifice plate 16 corresponding to the energy generating element 1.

As illustrated in FIG. 3C, on the surface of the first substrate 17 in the cross-sectional view from the arrow B direction, the first thermoelectric conversion element 5 and the second thermoelectric conversion element 6 (thermoelectric conversion elements) are disposed adjacent to each other. The orifice plate 16 and the first substrate 17 form an individual pressure chamber 3 for each set of the ejection nozzle 2 and the energy generating element 1. The pressure chamber 3 includes a partition wall between the ejection nozzle 2 and the energy generating elements 1, which are disposed at a plurality of positions in the Y direction. The energy generating element 1 is heated based on inputted driving signals, so as to generate film boiling in the ink. Ink is ejected from the ejection nozzle 2 by the growth energy of the generated foam.

The partition wall forming the pressure chamber 3 also constitutes a part of the circulation flow passage 7, which includes the first thermoelectric conversion element 5 and the second thermoelectric conversion element 6 which are disposed in the Y direction. The sizes of the first thermoelectric conversion element 5 and the second thermoelectric conversion element 6 may be the same or different. In the case of this U-shaped flow passage configuration, the thermoelectric conversion element and the energy generating element are alternately disposed in the direction of the ejection nozzle row (Y direction).

The structure of the recording element substrate 4 of Embodiment 1 will be described in detail.

As illustrated in FIG. 3A, the recording element substrate 4 includes a common flow passage 12 which communicates with the inflow port 8 and the outflow port 9 respectively. The ink ejection portion 40 is disposed at a plurality of positions aligned in the Y direction (third direction), and the common flow passage 12 is a common flow passage for the plurality of ink ejection portions 40. A plurality of circulation flow passages 7, disposed corresponding to a plurality of ink ejection portions 40, extend in the X direction (second direction) among the plurality of ink ejection portions 40, so that the upstream side flow passage 71 crosses with the row of the plurality of ink ejection portions 40. The common flow passage 12 is disposed to extend in the Y direction, at positions on one side of the inflow ports 8 and the outflow ports 9 in the X direction, and communicates respectively with the plurality of inflow ports 8 and the plurality of outflow ports 9, which are disposed corresponding to the plurality of ink ejection portions 40. The plurality of energy generating elements 1 and the plurality of first thermoelectric conversion elements 5, which are provided for a plurality of ink ejection portions 40 respectively, are disposed alternately to align in the Y direction (third direction).

As illustrated in FIGS. 3B and 3C, the first substrate 17 has a first surface 171 on which the ink ejection portion 40, the circulation flow passage 7 and the thermoelectric conversion elements 5 and 6 are disposed. The first flow passage member 13 is a flow passage forming member which is layered on the first surface 171 of the first substrate 17, and includes a partition wall 130 constituting a part of the circulation flow passage 7. The orifice plate 16, in which the ejection nozzle 2 is opened, is layered on the first flow passage member 13 on the opposite side of the first substrate 17. The pressure chamber 3 and the circulation flow passage 7 are defined by the first surface 171 of the first substrate 17, the partition wall 130 and the orifice plate 16. The first substrate 17 includes a through hole 173, which penetrates between the first surface 171 of the first substrate 17 and a second surface 172, which is the rear surface of the firs substrate 171, in the Z direction (first direction), on the one side of the inflow port 8 and the outflow port 9 in the X direction (second direction). The common flow passage 12 is defined by the through hole 173, the flow passage member 13 and the orifice plate 16.

As illustrated in FIG. 3A, the first thermoelectric conversion element 5 and the second thermoelectric conversion element 6 are disposed adjacent to each other in the X direction (second direction) at positions different from the energy generating elements 1 in the Y direction (third direction). The partition wall 130 of the first flow passage member 13 includes a first partition wall portion 131 which extends in the X direction, so as to demarcate a plurality of circulation flow passages 7, which correspond to a plurality of ink ejection portions 40, in the Y direction. In the individual circulation flow passage 7, the partition wall 130 also includes a second partition wall portion 132 which extends in the X direction, so as to demarcate the energy generating element 1, the first thermoelectric conversion element 5, and the second thermoelectric conversion element 6 in the Y direction. The side surface on one side of the second partition wall portion 132 in the Y direction constitutes a part of the upstream side flow passage 71, and the side surface on the other side of the second partition wall portion 132 in the Y direction constitutes a part of the downstream side flow passage 72 and the pressure chamber 3.

Next the circulation flow passage 7 in Embodiment 1, where ink is supplied from the inflow port 8 to the pressure chamber 3, as illustrated in FIG. 3A, and is discharged to the common flow passage 12 via the outflow port 9, will be described. As a mechanism to generate a flow inside the circulation flow passage 7, the first thermoelectric conversion element 5 and the second thermoelectric conversion element 6 are disposed between the inflow port 8 and the energy generating element 1.

A theory on the circulation method using the thermoelectric conversion element according to Embodiment 1 will be described. When ink is overheated by the thermoelectric conversion element, foam grows due to the film of the ink boiling. Here in the circulation flow passage 7, the thermoelectric conversion elements 5 and 6 are located closer to the inflow port 8 side than to the outflow port 9 side, and a first flow resistance R1 between the thermoelectric conversion elements 5 and 6 and the inflow port 8 becomes smaller than a second flow resistance R2 between the thermoelectric conversion elements 5 and 6 and the outflow port 9. Therefore the foam generated by the film of the ink boiling grows more toward the supply flow passage side where the flow resistance is low. Then in the foam contracting step, ink flows in so as to compensate for the contracted capacity, hence the flow of ink from the supply flow passage side, where foam has largely grown, becomes faster than flow from the discharge flow passage side. Therefore, as illustrated in FIG. 3A, the flow is generated from the supply flow passage side to the discharge flow passage side, and ink is circulated thereby.

When the ink in the pressure chamber 3 is consumed by the ejection operation in the above configuration, fresh unthickened fresh ink is supplied to the ejection nozzles 2. Even in the state where the ejection operation is not performed, ink is still circulated in the circulation flow passage 7, and fresh ink is supplied to the ejection nozzles 2. Here, a filter 14 may be installed to prevent the entry of foreign substances, bubbles, and the like to the flow passage and the ejection nozzles 2. If the filter 14 is disposed not only at an entry portion of the inflow port 8 through which ink flows into the circulation flow passage 7, but also at the outflow port 9, then the entry of foreign substances can be prevented in the case where ink is supplied through the outflow port 9 (discharge flow passage) during the ejection operation.

The amount of this circulation flow is influenced by the ratio of flow resistances R1 and R2, and the size of bubbles. In the case where the energy generating element, to generate circulation flow, is the thermoelectric conversion element, as in the case of Embodiment 1, the flow resistance ratio R1/R2 may be set to the 0.05 to 0.4 range. By setting the flow resistance ratio R1/R2 to this range, the circulation flow inside the circulation flow passage 7 can be increased. In Embodiment 1, the thermoelectric conversion elements 5 and 6 are disposed adjacent to each other in the cross-sectional view from the arrow B direction, but the present invention is not limited to this, as long as the above resistance relationship can be established with the thermoelectric conversion elements 5 and 6.

The adjustment of the flow resistance ratio R1/R2 is not limited to a specific method, but may be performed by changing the positions of the thermoelectric conversion elements 5 and 6 on the circulation flow passage 7. In other words, the magnitudes of the flow resistance R1 and the flow resistance R2 are changed by changing the flow passage distance between the thermoelectric conversion elements 5 and 6 and the inflow port 8, and the flow passage distance between the thermoelectric conversion elements 5 and 6 and the outflow port 9. Another method is to change the cross-sections of the flow passages on both sides of the thermoelectric conversion element 5, and on both sides of the thermoelectric conversion element 6, or both the flow passages distances and the cross-sections of the flow passages may be changed. To change the cross-sections of the flow passages, a structure to interrupt the flow may be disposed on the flow passage, and the flow resistances R1 and R2 may be changed thereby, for example.

### Description of Driving Signal

The circulation flow attenuates over time, and stops when a predetermined time passes. Hence in order to constantly generate the circulation flow, the driving of the thermoelectric conversion element for generating the circulation flow need be repeated. The driving cycle of the thermoelectric conversion element for generating the circulation flow is not especially limited, as long as the thickened ink in the ejection nozzles 2 can be discharged.

Normally the effect of discharging the thickened ink increases as the driving frequency of the thermoelectric conversion element for generating the circulation flow is higher and the foaming cycle is shorter, but if the frequency is too high, such a problem as reboiling may be generated, that is, an increase in the driving frequency has limitations. Therefore in Embodiment 1, two thermoelectric conversion elements for generating the circulation flow (first thermoelectric conversion element 5 second thermoelectric conversion element 6) are disposed, and are driven at different timings from each other, so as to increase the circulation efficiency by interpolating the driving with each other. In Embodiment 1, as a main element, the first thermoelectric conversion element 5 is disposed at a position most effective in the 0.05 to 0.4 range of the flow resistance ratio R1/R2, and as a sub-element, the second thermoelectric conversion element 6 is disposed adjacent to the first thermoelectric conversion element 5, as illustrated in FIG. 3A.

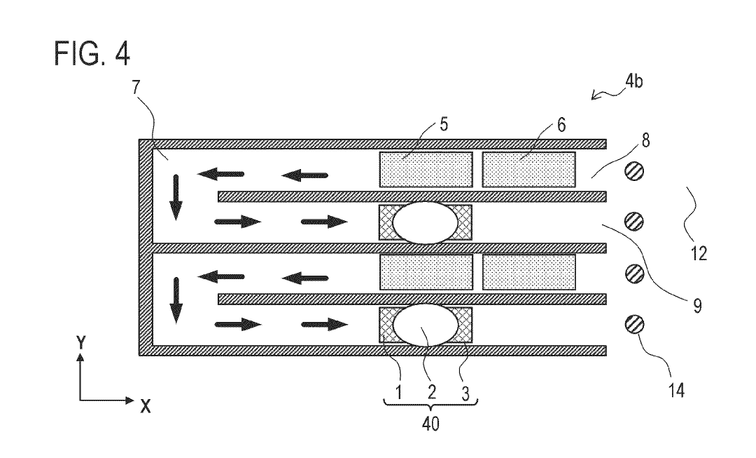

The second thermoelectric conversion element 6 may be disposed on the supply flow passage side, as in the case of a recording element substrate 4b according to a modification illustrated in FIG. 4.

The sizes of the first thermoelectric conversion element 5 and the second thermoelectric conversion element 6 may be the same size, since the same voltage pulses can be inputted. Even in the case where the thermoelectric conversion elements have different sizes in order to suppress the total power consumed by the plurality of thermoelectric conversion elements, the thermoelectric conversion elements may be designed in the passage width direction to have the same width.

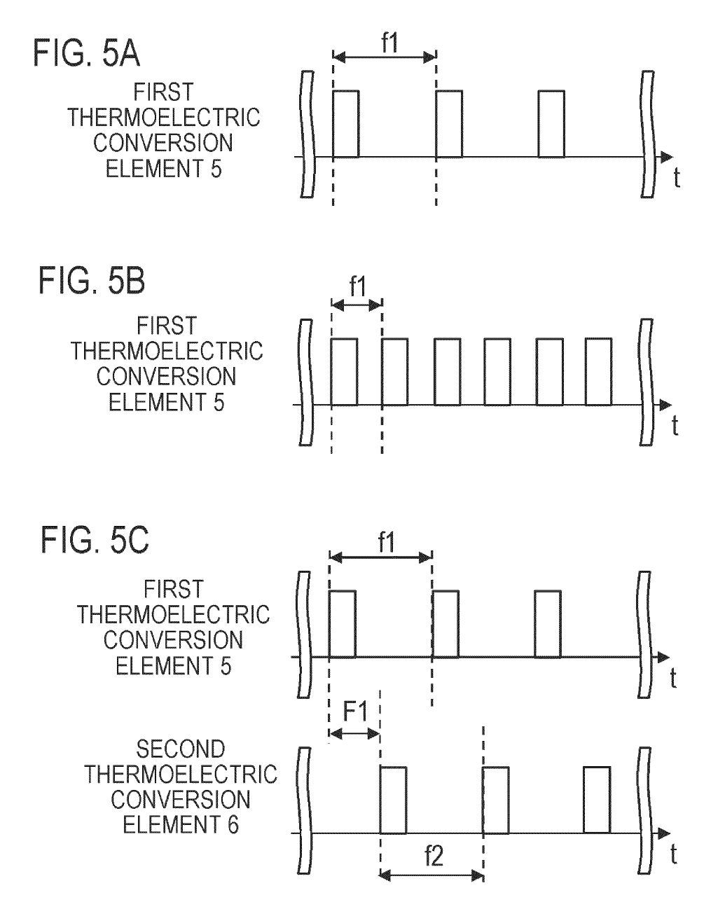

FIG. 5C indicates the timings of driving signals. FIG. 5C indicates the driving signals in the first thermoelectric conversion element 5 and the second thermoelectric conversion element 6, and here the ejection pulses are paused in advance before driving the thermoelectric conversion elements 5 and 6. Further, as mentioned above, the first thermoelectric conversion element 5 is disposed at an optimum position where the flow rate is highest. If the first thermoelectric conversion element 5 and the second thermoelectric conversion element 6 are driven at the same timing in this disposition, foaming by the second thermoelectric conversion element 6 changes the flow resistance ratio before and after the first thermoelectric conversion element 5, and the flow rate may deteriorate thereby. To prevent this, the first thermoelectric conversion element 5 and the second thermoelectric conversion element 6 are alternately driven at different timings. The driving frequency of the voltage pulse applied to the first thermoelectric conversion element 5 and to the second thermoelectric conversion element 6 may be the same or different.

### Effects

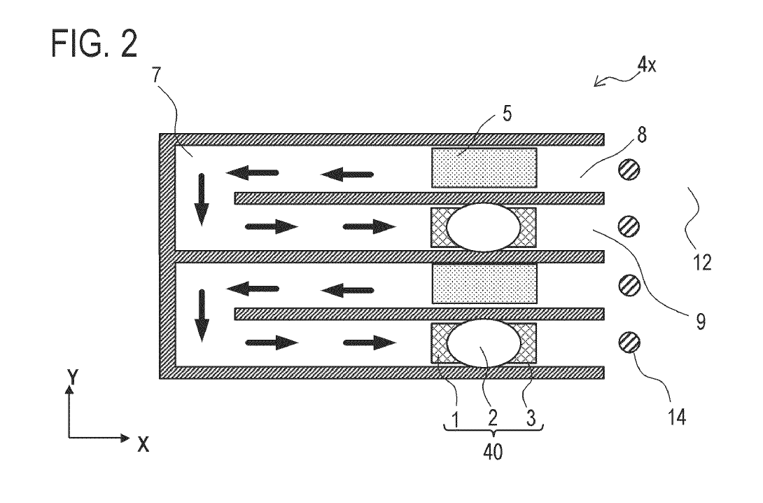

A configuration of a comparative example will be described with reference to FIG. 2, and FIGS. 5A to 5C, to compare with Embodiment 1. FIG. 2 is a perspective view of a U-shaped flow passage configuration of a recording element substrate 4x of the comparative example, where one thermoelectric conversion element 5 is disposed for one ejection nozzle 2, from the side facing the ejection nozzles 2 (-Z direction). FIG. 5A indicates a timing of a driving signal of a voltage pulse that is applied to the energy generating element 1 according to the comparative example. In FIG. 5A, time t is plotted on the abscissa, and the driving timing f of the voltage pulse indicates a driving frequency that is expressed by an inverse number of time t (that is, the same for the following description). A case where the thermoelectric conversion element 5 is disposed at an optimum position where the flow rate becomes highest, and is driven at an appropriate driving frequency at which foaming is not affected by local heating (e.g. f1 = 15 kHz, f2 = 15 kHz in FIG. 5A) will be described.

The flow rate can be higher in the case of FIG. 5A, where only the first thermoelectric conversion elements 5 is driven at an optimum position where the flow rate is higher, compared with the case of FIG. 5C, such as Embodiment 1, where the two thermoelectric conversion elements 5 and 6 are alternately driven. This is because in Embodiment 1, the flow rate of the second thermoelectric conversion element 6 (sub-element) is slightly lower compared with the first thermoelectric conversion element 5.

In the case where an even higher flow rate is needed, on the other hand, if only the driving frequency of f1 of the first thermoelectric conversion element 5 remains at 30 kHz, for example, as illustrated in FIG. 5B, local heating at the thermoelectric conversion elements become high. This may cause in a foaming failure, resulting in a drop in the flow rate of the pump.

As a comparison with this comparative example, FIG. 5C indicates a driving timing of a voltage pulse that is applied to the thermoelectric conversion elements 5 and 6 of Embodiment 1. For example, the driving frequency f1 of the first thermoelectric conversion element 5 is set to 15 kHz, and the driving frequency f2 of the second thermoelectric conversion element 6 is set to 15 kHz, and is driven by shifting from the first thermoelectric conversion element 5 by a half cycle. In this case, the frequency F1 between the first thermoelectric conversion element 5 and the second thermoelectric conversion element 6 becomes 30 kHz. Therefore the temperature increase of ink by local heating, when driving one thermoelectric conversion element at high frequency, can be suppressed by separating and driving the two thermoelectric conversion elements. Further, by repeatedly driving the two thermoelectric conversion elements alternately at shifted timings, the flow rate can be increased, and fresh ink can be supplied to the nozzle portions, which can suppress the thickening of ink at the nozzle portions.

### Embodiment 2

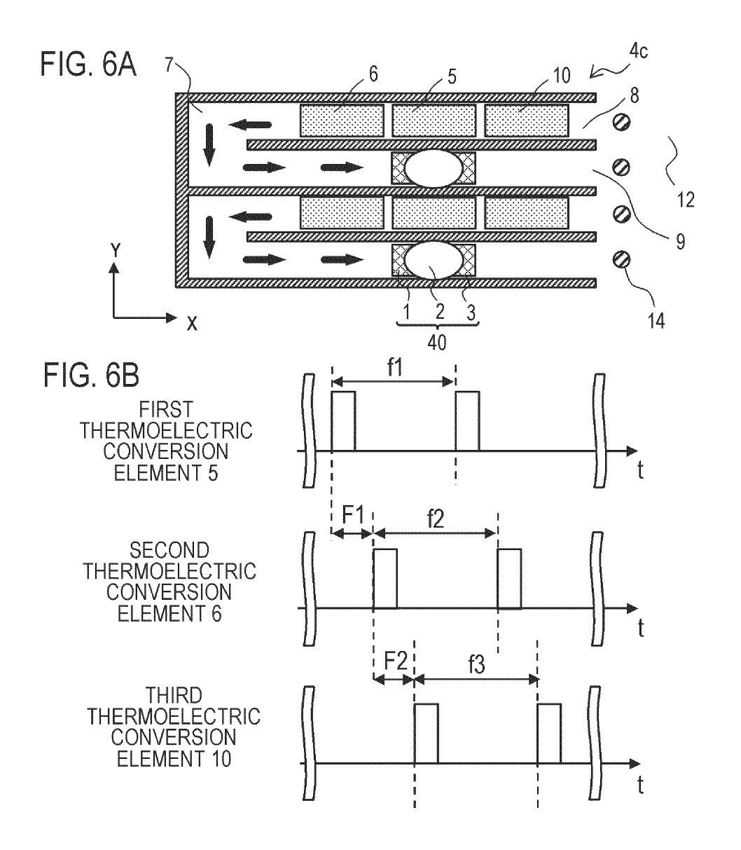

A circulation configuration of a recording element substrate 4c according to Embodiment 2 of the present disclosure will be described with reference to FIGS. 6A and 6B, focusing on aspects different from the recording element substrate 4 of Embodiment 1. Matters which are not especially described here in Embodiment 2 are the same as Embodiment 1.

### Description on Recording Element

FIG. 6A is a perspective view of a part of the flow passage near the ejection nozzles of the recording element substrate 4c according to Embodiment 2 from the side facing the ejection nozzles (-Z direction). In Embodiment 1, the first thermoelectric conversion element 5 and the second thermoelectric conversion element 6 are disposed adjacent to each other, but in the configuration of Embodiment 2, the first thermoelectric conversion element 5, the second thermoelectric conversion element 6, and the third thermoelectric conversion element 10 are disposed in a line.

In Embodiment 2, just like Embodiment 1, the first thermoelectric conversion element 5 is disposed as the main element, and the second thermoelectric conversion element 6 and the third thermoelectric conversion element 10 are disposed as sub-elements, as illustrated in FIG. 6A. In Embodiment 2, the first thermoelectric conversion element 5 is disposed at the center, and the second thermoelectric conversion element 6 and the third thermoelectric conversion element 10 are disposed adjacent thereto on each side, as illustrated in FIG. 6A. Specifically, the third thermoelectric conversion element 10 is disposed next to the first thermoelectric conversion element 5, on the side of the circulation flow passage 7 closer to the inflow port 8 than the energy generating element 1, that is, on the opposite side of the second thermoelectric conversion element 6. In other words, the third thermoelectric conversion element 10 is disposed on the circulation flow passage 7 at a position closer to the inflow port 8 than the first thermoelectric conversion element 5 and the second thermoelectric conversion element 6 (closest to the inflow port 8 among the three thermoelectric conversion elements). The positional order of the first thermoelectric conversion element 5, the second thermoelectric conversion element 6 and the third thermoelectric conversion element 10 is not limited thereto, as long as the order of the resistance relationship among the thermoelectric conversion elements is established.

### Description of Driving Signal

FIG. 6B indicates the driving timings of the voltage pulses that are applied to the three thermoelectric conversion elements 5, 6 and 10. In Embodiment 2, the first to third thermoelectric conversion elements 5, 6 and 10 are driven at different timings from each other, and the three thermoelectric conversion elements 5, 6 and 10 are repeatedly driven to constantly generate the circulation flow, just like Embodiment 1. For example, the three thermoelectric conversion elements 5, 6 and 10 are repeatedly driven in this sequence.

### Effects

As illustrated in FIG. 6B, the driving frequency f1, f2 and f3 of the first, second and third thermoelectric conversion elements 5, 6 and 10 are set to 10 kHz respectively, for example, and the first thermoelectric conversion element 5, the second thermoelectric conversion element 6, and the third thermoelectric conversion element 10 are driven sequentially shifted by a 1/3 cycle. In this case, the frequency F1 between the first thermoelectric conversion element 5 and the second thermoelectric conversion element 6 and the frequency F2 between the second thermoelectric conversion element 6 and the third thermoelectric conversion element 10 becomes F1 = F2 = 30 kHz. Thereby the flow rate can be further increased than the case of driving the two thermoelectric conversion elements 5 and 6 alternately (as in the case of Embodiment 1), and local heating can be suppressed since driving is separated. According to this configuration, the number of thermoelectric conversion elements that can be disposed is limited depending on the sizes of the thermoelectric conversion elements, the length of the circulation flow passage, the distance between the ejection nozzle rows, and the like, but it is possible to improve the circulation efficiency in the circulation flow passage.

### (Embodiment 3) Three-dimensional Flow Passage Configuration

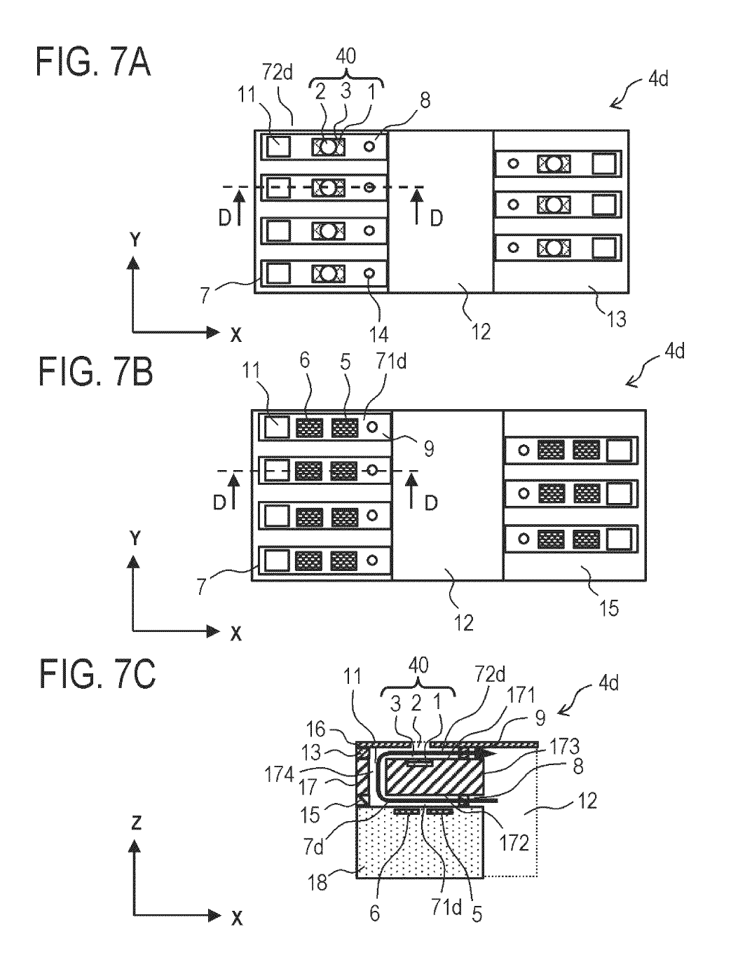

A circulation configuration of a recording element substrate 4d according to Embodiment 3 of the present disclosure will be described with reference to FIGS. 7A to 7C, focusing on aspects different from the recording element substrates of Embodiments 1 and 2. Matters which are not especially described here in Embodiment 3 are the same as the embodiments described above.

### Description on Recording Element

FIGS. 7A to 7C are diagrams depicting the flow passage configuration and wiring near the ejection nozzles of the recording element substrate 4d according to Embodiment 3. FIGS. 7A and 7B are perspective views of the recording element substrate 4d from the side facing the ejection nozzles (-Z direction), and FIG. 7C is a cross-sectional view of FIGS. 7A and 7B from the arrow D direction. FIG. 7A indicates the configuration from the orifice plate 16 to the first flow passage member 13, and FIG. 7B indicates the configuration from the first substrate 17 to the second substrate 18.

As illustrated in FIG. 7C, the recording element substrate 4d of Embodiment 3 has a configuration where the second substrate 18, the second flow passage member 15 (second flow passage forming member), the first substrate 17, the first flow passage member 13 and the orifice plate 16 are sequentially layered in the Z direction. On the surface of the first substrate 17 (first surface 171), the energy generating element 1 (thermoelectric conversion element) is disposed, and the ejection nozzle 2 is formed at a position of the orifice plate 16 corresponding to the energy generating element 1. Between the orifice plate 16 and the first substrate 17, an individual pressure chamber 3 for each ejection nozzle 2 and energy generating element 1 is formed by the first flow passage member 13. The pressure chamber 3 has a partition wall between the ejection nozzles 2 and the energy generating elements 1, which are disposed at a plurality of positions in the Y direction.

A structure of the recording element substrate 4d of Embodiment 3 will be described in detail.

As illustrated in FIG. 7C, the circulation flow passage 7d of the recording element substrate 4d is approximately a U-shaped flow passage in its entirety when viewed in the Y direction (third direction). The inflow port 8 and the outflow port 9 are disposed in a line in the Z direction (first direction), which is a direction where the ejection nozzle 2 is opened (ink ejecting direction), and are both located on one side in the X direction (second direction) with respect to the ink ejection portion 40. The circulation flow passage 7d includes an upstream side flow passage 71d, which extends from one side to the other side of the inflow port 8 in the X direction, and a downstream side flow passage 72d, which extends from the other side to one side in the X direction by turning the direction thereof to the opposite direction from the upstream side flow passage 71d. The thermoelectric conversion elements 5 and 6 are disposed on the upstream side flow passage 71d, and the ink ejection portion 40 is disposed on the downstream side flow passage 72d. In other words, the ink ejection portion 40 and the thermoelectric conversion elements 5 and 6 are disposed at different positions in the Z direction.

As illustrated in FIGS. 7A and 7B, the ink ejection portion 40 is disposed at a plurality of positions aligning in the Y direction. The upstream side flow passage 71d and the downstream side flow passage 72d extend in the X direction respectively, and are also disposed in a line in the Z direction, as illustrated in FIG. 7C. The common flow passage 12 extends in the Y direction on one side of the inflow port 8 and the outflow port 9 in the X direction, and communicates respectively with the plurality of inflow ports 8 and the plurality of outflow ports 9 which are disposed corresponding to the plurality of ink ejection portions 40.

As illustrated in FIGS. 7A to 7C, the plurality of circulation flow passages 7d (upstream side flow passage 71d, downstream side flow passages 72d), which are disposed corresponding to the plurality of ink ejection portions 40, are aligned in the Y direction. As illustrated in FIG. 7A, the plurality of energy generating elements 1, which are disposed corresponding to the plurality of ink ejection portions 40, are also aligned in the third direction. As illustrated in FIG. 7B, the plurality of first thermoelectric conversion elements 5 and the plurality of second thermoelectric conversion elements 6, which are disposed corresponding to the plurality of ink ejection portions 40, are aligned in the Y direction respectively.

As illustrated in FIG. 7C, the first substrate 17 has: the first surface 171 on which the ink ejection portion 40 is disposed, and which constitutes a part of the downstream side flow passage 72d and the pressure chamber 3; and the second surface 172 which is a rear surface of the first surface 171, and constitutes a part of the upstream side flow passage 71d. The first substrate 17 also includes a connection hole 174 constituting a through flow passage 11 (connection flow passage), which penetrates between the first surface 171 and the second surface 172 in the Z direction, and connects the upstream side flow passage 71d and the downstream side flow passage 72d on the circulation flow passage 7d.

The first flow passage member 13 is layered on the first surface 171 of the first substrate 17, and constitutes a part of the downstream side flow passage 72d and the pressure chamber 3. The orifice plate 16, in which the ejection nozzle 2 is opened, is layered on the first flow passage member 13 on the opposite side of the first substrate 17, and constitutes a part of the downstream side flow passage 72d and the pressure chamber 3. The second flow passage member 15 is layered on the second surface 172 of the first substrate 17, and constitutes a part of the upstream side flow passage 71d. The second substrate 18 is layered on the second flow passage member 15 on the opposite side of the first substrate 17. On the side of the second substrate 18 facing the second flow passage member 15, the first thermoelectric conversion element 5 and the second thermoelectric conversion element 6 are disposed, and constitute a part of the upstream side flow passage 71d.

On one side of the inflow port 8 and the outflow port 9 in the X direction, the common flow passage 12 is formed by a common hole which sequentially penetrates the first flow passage member 13, the first substrate 17, the second flow passage member 15, and the second substrate 18 in the Z direction.

Now a circulation flow passage 7d, which supplies ink to the pressure chamber 3 and discharges the ink to the common flow passage 12, according to Embodiment 3, will be described. As illustrated in FIG. 7C, the second substrate 18, the second flow passage member 15, the first substrate 17, the first flow passage member 13, and the orifice plate 16 become a wall respectively, and constitute an individual circulation flow passage 7d for each recording element substrate 4d. The circulation flow passage 7d is constituted of the upstream side flow passage 71d, the through flow passage 11, and the downstream side flow passage 72d. The upstream side flow passage 71d is formed between the first substrate 17 and the second substrate 18 by the second flow passage member 15. The through flow passage 11 is formed by the connection hole 174 of the first substrate 17. The downstream side flow passage 72d is formed between the first substrate 17 and the orifice plate 16 by the first flow passage member 13. The ink that flows from the common flow passage 12 into the circulation flow passage 7d via the inflow port 8 is supplied to the pressure chamber 3 via the upstream side flow passage 71d and the through flow passage 11. The ink collected from the pressure chamber 3 without being ejected is discharged from the outflow port 9 to the common flow passage 12 via the downstream side flow passage 72d.

As a mechanism to generate the flow inside the circulation flow passage 7d, the first thermoelectric conversion element 5 and the second thermoelectric conversion element 6 are disposed in the mid-portion of the circulation flow passage 7d. The thermoelectric conversion elements 5 and 6 are disposed on the surface of the second substrate 18, at positions facing the second surface 172, which is the opposite side surface (rear surface) of the surface where the energy generating element 1 of the first substrate 17 is disposed.

In Embodiment 3, as a main element, the first thermoelectric conversion element 5 is disposed at a most effective position where the flow resistance ratio R1/R2 is in the 0.05 to 0.4 range, and as a sub-element, the second thermoelectric conversion element 6 is disposed on the second substrate 18, which is the same as the first thermoelectric conversion element 5. The position of the first thermoelectric conversion element 5 and the second thermoelectric conversion element 6 is not limited to the above positional configuration, but the thermoelectric conversion elements 5 and 6 may be disposed on the first substrate 17 as long as the predetermined resistance relationship between the thermoelectric conversion elements 5 and 6 on the circulation flow passage 7d is established. Further, in Embodiment 3, the two thermoelectric conversion elements are disposed on the circulation flow passage, but three or more thermoelectric conversion elements may be disposed, as in the case of Embodiment 2.

The flow direction of the circulation flow passage 7d is indicated by the arrow in FIG. 7C. If the ink ejection direction at the ejection nozzle 2 is from the bottom to the top, the flow direction of the circulation flow passage 7d is from the bottom to the top in the through flow passage 11, and the ink supplied from the through flow passage 11 to the pressure chamber 3 flows into the common flow passage 12 through the outflow port 9.

If ink inside the pressure chamber 3 is consumed by the ejection operation in this configuration, unthickened fresh ink is supplied to the ejection nozzle 2. Even in the state where the ejection operation is not performed, ink is circulated in the circulation flow passage, and fresh ink is supplied to the ejection nozzle 2.

### Effects

In the configuration of Embodiment 3 described above, when ink is ejected from the ejection nozzle in the direction from the bottom to the top, the thermoelectric conversion elements 5 and 6 are disposed below the energy generating element 1. Further, the thermoelectric conversion elements 5 and 6 are disposed on the surface of the second substrate 18 at positions facing the rear surface (second surface 172) of the surface of the first substrate 17, where the energy generating element 1 is disposed. In the case of a two-dimensional U-type flow passage configuration along the X direction and the Y direction, as described in Embodiments 1 and 2, the inflow port 8 and the outflow port 9 are disposed close to each other, which may cause the thickening of ink by recirculation. In Embodiment 3, however, the configuration is three-dimensional in the Z direction, hence the inflow port 8 and the outflow port 9 can be distanced, and the thickening of ink by recirculation can be suppressed by increasing the driving frequency of the thermoelectric conversion elements 5 and 6, to increase the flow rate.

Further, according to this configuration, the resolution of arraying the recording element substrates 4d is less influenced by the resolution of the arrays of the thermoelectric conversion elements 5 and 6, hence the resolution of the recording element substrates 4d can be increased. Also by making the circulation flow passages 7d independent, the flow speed can be increased, and the energy efficiency for circulation in the thermoelectric conversion elements 5 and 6 can be increased.

### Embodiment 4

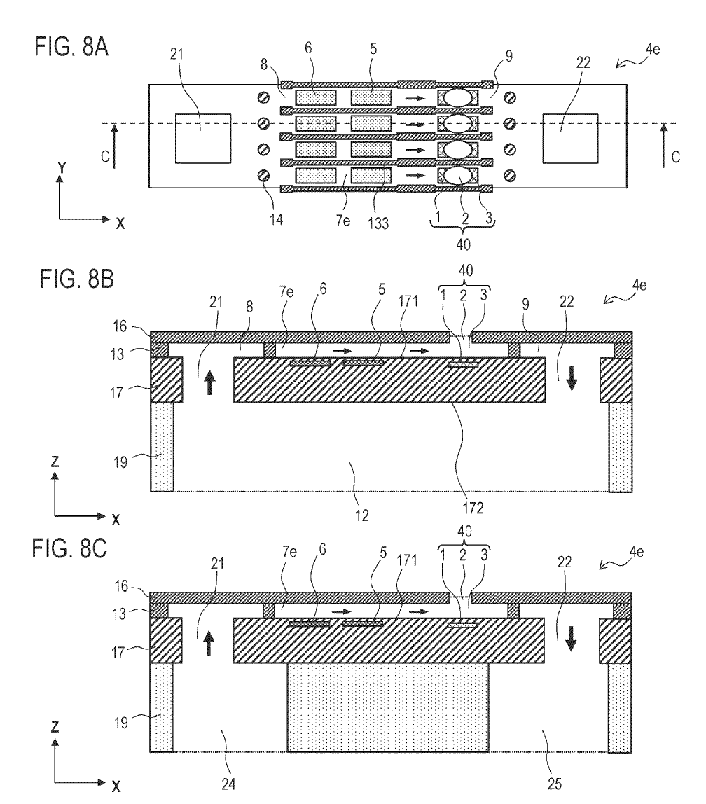

A circulation configuration of a recording element substrate 4e according to Embodiment 4 of the present disclosure will be described with reference to FIGS. 8A to 8C, focusing on aspects different from the recording element substrates of Embodiments 1 to 3. Matters which are not especially described here in Embodiment 4 are the same as the embodiments displayed above.

FIGS. 8A to 8C are diagrams depicting a part of the flow passage near the ejection nozzles of the recording element substrate 4e according to Embodiment 4. FIG. 8A is a perspective view of the recording element substrate 4e viewed from the side facing the ejection nozzles (-Z direction). FIGS. 8B and 8C are cross-sectional views of FIG. 8A from the arrow C direction.

On the surface (first surface 171) of the first substrate 17, the energy generating element 1 (thermoelectric conversion element) is disposed, and the ejection nozzle 2 is formed at the position of the orifice plate 16 corresponding to the energy generating element 1. Also on the surface of the first substrate 17, the first thermoelectric conversion element 5 and the second thermoelectric conversion element 6 are disposed adjacent to the energy generating element 1, in a direction vertical to the ejection nozzle row in the Y direction. The pressure chamber 3 includes a partition wall between the plurality of ejection nozzles 2 disposed in the Y direction and the energy generating element 1. The partition wall constituting the pressure chamber 3 extends in a direction vertical to the Y direction, which is the array direction of the plurality of ejection nozzles 2, and constitutes the circulation flow passage 7e, including the first thermoelectric conversion element 5 and the second thermoelectric conversion element 6. The supply side through flow passage 21, which communicates with the inflow port 8, is formed penetrating the first substrate 17. In the same manner, the discharge side through flow passage 22, which communicates with the outflow port 9, is formed penetrating the first substrate 17.

A structure of the recording element substrate 4e of Embodiment 4 will be described in detail.

As illustrated in FIG. 8A, in Embodiment 4, the circulation flow passage 7e extends approximately linear along the X direction (second direction). The inflow port 8 is located on one side of the pressure chamber 3 in the X direction, and the outflow port 9 is located on the other side of the pressure chamber 3 in the X direction. In other words, the circulation flow passage 7e is a flow passage extending in the X direction such that the inflow port 8, the pressure chamber 3 and the outflow port 9 are disposed in a line in this sequence in the X direction. The thermoelectric conversion elements 5 and 6 are disposed on the circulation flow passage 7e on the side closer to the inflow port 8 than the energy generating element 1.

As illustrated in FIG. 8A, the ink ejection portion 40 is disposed at a plurality of positions aligned in the Y direction (third direction), and the circulation flow passage 7e is also disposed at a plurality of positions aligned in the Y direction. The plurality of energy generating elements 1 corresponding to the plurality of ink ejection portions 40 are also aligned in the Y direction, and the plurality of first thermoelectric conversion elements 5 and the plurality of second thermoelectric conversion elements 6 are also aligned in the Y direction respectively. The plurality of inflow ports 8 corresponding to the plurality of circulation flow passages 7e are also aligned in the Y direction, and the plurality of outflow ports 9 are also aligned in the Y direction.

As illustrated in FIG. 8B, the plurality of inflow ports 8 and the plurality of outflow ports 9 are configured so as to communicate with each other via the supply side through flow passage 21, the discharge side through flow passage 22, the common flow passage 12, and the like. The supply side through flow passages 21 is formed by a through hole on one side of the inflow port 8 on the first substrate 17 in the X direction (outer side of the inflow port 8), so as to penetrate between the first surface 171 and the second surface 172 in the Z direction. The discharge side through flow passage 22 is formed by a through hole on the other side of the outflow port 9 on the first substrate 17 in the X direction (outer side of the outflow port 9), so as to penetrate between the first surface 171 and the second surface 172 in the Z direction. The common flow passage 12 is formed on the side of the second surface 172 of the first substrate 17, so as to communicate respectively with the supply side through flow passage 21 and the discharge side through flow passage 22. The common flow passage 12 is defined by the second surface 172 of the first substrate 17 and the second flow passage member 19 which is layered thereon, and communicates respectively with the plurality of the circulation flow passages 7e via the supply side through flow passage 21 and the discharge side through flow passage 22.

As illustrated in FIG. 8A, the supply side through flow passage 21 communicates respectively with the plurality of inflow ports 8, which are disposed corresponding to the plurality of ink ejection portions 40, and the discharge side through flow passage 22 communicates respectively with the plurality of outflow ports 9, which are disposed corresponding to the plurality of ink ejection portions 40.

As illustrated in FIG. 8B, the first flow passage member 13, which is layered on the first surface 171 of the first substrate 17, includes a plurality of partition walls 133 which extend in the X direction among the plurality of energy generating elements 1 which are aligned in the Y direction corresponding to the plurality of ink ejection portions 40. The pressure chamber 3 and the circulation flow passage 7e are defined by: the orifice plate 16, in which the ejection nozzle 2 is opened and which is layered on the opposite side of the first substrate 17 with respect to the first flow passage member 13; the first surface 171 of the first substrate 17; and the partition wall 133.

The supply side through flow passage 21 and the discharge side through flow passage 22 may be formed by the second flow passage member 19, as illustrated in FIG. 8B, and share the common flow passage 12, which extends in the ejection nozzle row direction (Y direction). The first substrate 17 may be thin, since the influence of pressure loss need be minimized to ensure refilling into the ejection nozzles 2. However, in order to suppress the influence of the thickening of ink by recirculation, the first substrate 17 may be thick, so that the path between the supply side through flow passage 21 and the discharge side through flow passage 22 can be lengthened, as illustrated in FIG. 8B.

Instead, in the second flow passage member 19 which is layered on the second surface 172 of the first substrate 17, the supply side common flow passage 24 and the discharge side common flow passage 25, which penetrate the second flow passage member 19 respectively, may be formed, and then communicate with each other outside the recording head, as illustrated in FIG. 8C. The supply side common flow passage 24 is formed to extend in the ejection nozzle row direction (Y direction), and communicate respectively with the plurality of circulation flow passages 7e via the supply side through flow passage 21. In the same manner, the discharge side common flow passage 25 is formed to extend in the ejection nozzle row direction, and communicate respectively with the plurality of circulation flow passages 7e via the discharge side through flow passage 22. By separating the flow passage disposed in the second flow passage member 19 into the supply side common flow passage 24 and the discharge side common flow passage 25, the effect of suppressing the thickening of ink by recirculation can be more expected.

Next the circulation flow passage 7e in Embodiment 4, where ink is supplied from the supply side through flow passage 21 to the pressure chamber 3, as illustrated in FIG. 8A, and ink is discharged via the discharge side through flow passage 22, will be described. As a mechanism to generate flow inside the circulation flow passage 7e, the first thermoelectric conversion element 5 and the second thermoelectric conversion element 6 are disposed between the inflow port 8 and the energy generating element 1. In Embodiment 4, a flow is generated in the circulation flow passage 7e from the inflow port 8 side to the outflow port 9, and ink is circulated thereby, as illustrated in FIGS. 8A and 8B, based on a theory on the circulation method using the thermoelectric conversion elements as the energy generating elements for forming the circulation flow.

In Embodiment 4, the first thermoelectric conversion element 5 is disposed on a side closer to the energy generating element 1 than the second thermoelectric conversion element 6, as illustrated in FIGS. 8A to 8C, but the present invention is not limited to this configuration. In other words, just like Embodiments 1 to 3, the configuration is not limited to the above configuration, as long as the predetermined resistance relationship is established between the thermoelectric conversion elements 5 and 6 on the circulation flow passage 7e. In Embodiment 4, just like Embodiments 1 to 3, as a main element, the first thermoelectric conversion element 5 is disposed at a most effective position where the flow resistance ratio R1/R2 is in the 0.05 to 0.4 range, and the second thermoelectric conversion element 6 is disposed as a sub-element.

For the driving signals as well, the first thermoelectric conversion element 5 and the second thermoelectric conversion element 6 are alternately driven at different timings, as illustrated in FIG. 5C, just like Embodiment 1.

### Effects

Just like Embodiments 1 to 3, by separately driving the two thermoelectric conversion elements, local heating can be suppressed, and flow rate can be increased compared with the case of driving one thermoelectric conversion element at high frequency.

In some cases of the three-dimensional flow passage configuration of Embodiment 3, if the supply flow passage and the discharge flow passage are distanced from each other to prevent the thickening of ink by recirculation, the through flow passage need be long, which increases the flow resistance and drops the circulation efficiency. In the case of the configuration in Embodiment 4, on the other hand, the supply flow passage and the discharge flow passage are on a same line (a straight flow passage configuration), hence the influence of the thickening of ink by recirculation is suppressed even if the thermoelectric conversion element is disposed at a plurality of positions to increase the flow rate.

Further, the thermoelectric conversion elements and the ejection nozzles are disposed on a same line, hence the ejection nozzles can be disposed at high density, regardless the positions of the thermoelectric conversion elements.

### Embodiment 5

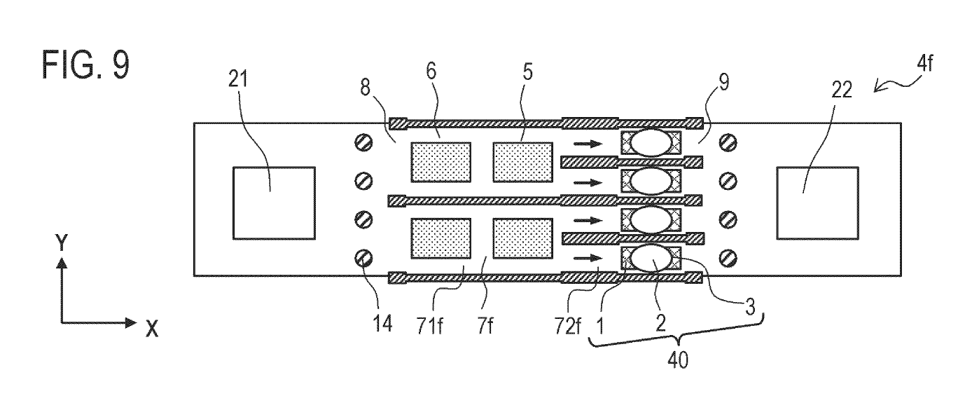

A circulation configuration of a recording element substrate 4f according to Embodiment 5 of the present disclosure will be described with reference to FIG. 9, focusing on aspects different from the recording element substrates of Embodiments 1 to 4. Matters which are not especially described here in Embodiment 5 are the same as the embodiments described above.

FIG. 9 is a diagram depicting a part of the flow passages near the ejection nozzles according to Embodiment 5. In the configuration of Embodiment 4, one first thermoelectric conversion element 5 and one second thermoelectric conversion element 6 are disposed for each ejection nozzle 2. In Embodiment 5, on the other hand, one first thermoelectric conversion element 5 and one second thermoelectric conversion element 6 are disposed for a plurality of ejection nozzles 2 respectively, as illustrated in FIG. 9.

A circulation flow passage 7f includes an upstream side flow passage 71f on which the thermoelectric conversion elements 5 and 6 are disposed, and a downstream side flow passage 72f on which the ink ejection portions 40 are disposed. The number of upstream side flow passages 71f (which are disposed corresponding to a plurality of ink ejection portions 40) disposed in a line in the Y direction is less than the number of the downstream side flow passages 72f (which are disposed corresponding to a plurality of ink ejection portions 40) disposed in a line in the Y direction. Some downstream side flow passages 72f, which are adjacent to each other in the Y direction, out of the plurality of downstream side flow passages 72f, communicate with the common inflow port 8 via a common upstream side flow passage 71f. In other words, ink that flows in through one inflow port 8 passes through one upstream side flow passage 71f, and then branches into some downstream side flow passages 72f, which are adjacent to each other in the Y direction, out of the plurality of downstream side flow passages 72f, and are then discharged through some outflow ports 9. This means that one upstream side flow passage 71f, out of the plurality of upstream side flow passages 71f, becomes a common flow passage, which communicates respectively with each of some downstream side flow passages 72f, which are adjacent to each other in the Y direction, out of the plurality of downstream side flow passages 72f disposed corresponding to the plurality of ink ejection portions 40. Since the number of upstream side flow passages 71f is less than the number of downstream side flow passages 72f, the number of thermoelectric conversion elements 5 and 6 disposed in a line in the Y direction is less than the number of ink ejection portions 40 disposed in a line in the Y direction.

In the configuration of Embodiment 5, the first thermoelectric conversion element 5 is disposed on the side closer to the ejection nozzle 2, and the second thermoelectric conversion element 6 is disposed on the side more distant from the ejection nozzle 2, and the first and second thermoelectric conversion elements are adjacent to each other in this state. However, the second thermoelectric conversion element 6 may be disposed on the side closer to the ejection nozzle 2, for example, or a plurality of thermoelectric conversion elements may be disposed in a line. In the configuration illustrated in FIG. 9, one first thermoelectric conversion element 5 and one second thermoelectric conversion element 6 are disposed for each set of two ejection nozzles, but one first thermoelectric conversion element 5 and one second thermoelectric conversion element 6 may be disposed for a set of three or more ejection nozzles.

### Effects

In the configuration of Embodiment 5 described above, one first thermoelectric conversion element 5 and one second thermoelectric conversion element 6 are disposed for a set of a plurality of ejection nozzles 2, hence the resolution of the thermoelectric conversion elements 5 and 6 is lower than that of the ejection nozzles 2. Since the sizes of the thermoelectric conversion elements 5 and 6 can be increased thereby, the energy efficiency in the circulation can be improved.

Further, in the case where the energy generating element for forming the circulation flow is the thermoelectric conversion element as in the case of Embodiment 5, a problem is that if the thickening of ink progresses in the feeding flow passage, steam bubbles generated on the thermoelectric conversion element become smaller as the viscosity of the ink increases, which drops the circulation frequency. In the case of the configuration of Embodiment 5, on the other hand, the feeding flow passage is disposed for each set of a plurality of ejection nozzles, hence the passage width of the feeding flow passage can be widened, which can suppress the resistance inside the feeding flow passage, and which minimizes the drop of circulation efficiency.

Further, according to Embodiment 5, the two thermoelectric conversion elements are separately driven, just like Embodiments 1 to 4 described above, hence local heating can be suppressed, and the flow rate can be increased compared with driving on one thermoelectric conversion element at high frequency.

### Embodiment 6

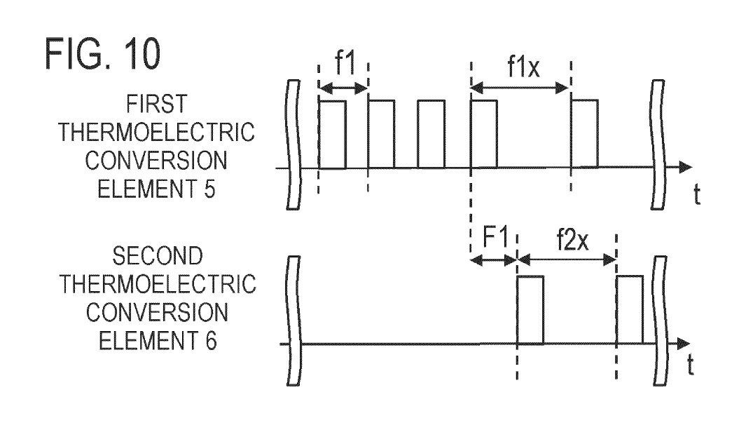

The driving signals of the thermoelectric conversion elements on a recording element substrate according to Embodiment 6 of the present disclosure will be described with reference to FIG. 10, focusing on aspects different from Embodiments 1 to 5. Matters which are not especially described here in Embodiment 6 are the same as the embodiments described above.

FIG. 10 indicates the driving timings of the voltage pulse that is applied to the thermoelectric conversion elements according to Embodiment6. In this configuration, it is assumed that the first thermoelectric conversion element 5 and the second thermoelectric conversion element 6 are adjacent to each other (the thermoelectric conversion elements form a pair). First just like Embodiment 1 to 5, the first thermoelectric conversion element 5 is disposed at an optimum position where the flow rate becomes highest, then only the first thermoelectric conversion element 5 is driven for several times at a 50 kHz high frequency. Then the first thermoelectric conversion element 5 and the second thermoelectric conversion element 6 are driven at f1x = f2x = 10 kHz driving frequency respectively. Here the first thermoelectric conversion element 5 and the second thermoelectric conversion element 6 are driven alternately until the local temperature of the first thermoelectric conversion element 5, which was driven at a high frequency, reaches the level that influences foaming.

In other words, in the driving control according to Embodiment 6, a first driving period, in which only the first thermoelectric conversion element 5 is driven for a plurality of times repeatedly, and a second driving period, in which the first thermoelectric conversion element 5 and the second thermoelectric conversion element 6 are alternately driven repeatedly, and are set. Further, for the first thermoelectric conversion element 5, the driving frequency of the first thermoelectric conversion element 5 is changed while driving is performed a plurality of times repeatedly from the first driving period to the second driving period. Specifically, the first thermoelectric conversion element 5 is driven at a relatively high frequency (first frequency) in the first driving period, and is then driven at a relatively low frequency (second frequency) in the subsequent second driving period.

Thereby the thickened ink in the circulation flow passage is supplied at a faster ink flow speed, and after the thickened ink flows out to a certain degree, the first thermoelectric conversion element 5 and the second thermoelectric conversion element 6 are driven at a lower driving frequency respectively. As a result, the efficiency to circulate the thickened ink around the ejection nozzles is improved while suppressing the rise in local temperature.

As described above, a concern in the case where the energy generating element for forming the circulation flow is the thermoelectric conversion element, is that steam bubbles generated on the thermoelectric conversion element become smaller due to the thickening of ink in the circulation flow passage, and circulation frequency drops thereby. In Embodiment 6, on the other hand, the thickened ink on the thermoelectric conversion element is replaced with fresh ink quickly by the initial driving at high frequency, hence the drop of efficiency of the thermoelectric conversion element can be suppressed.

In the configuration where the third thermoelectric conversion element 10 is further included in addition to the first thermoelectric conversion element 5 and the second thermoelectric conversion element 6, as in the case of Embodiment 2, the following control may be performed. In other words, a first driving period in which only the first thermoelectric conversion element 5 is driven a plurality of times repeatedly, and a second driving period in which the first thermoelectric conversion element 5, the second thermoelectric conversion element 6, and the third thermoelectric conversion element 10 are sequentially driven repeatedly, may be set. Further, for the first thermoelectric conversion element 5, the driving frequency of the first thermoelectric conversion element 5 may be changed while driving is performed a plurality of times repeatedly from the first driving period to the second driving period. Specifically, the first thermoelectric conversion element 5 is driven at a relatively high frequency (first frequency) in the first driving period, and is then driven at a relatively low frequency (second frequency) in the subsequent second driving period.

The configurations of the above embodiments may be combined with each other.

According to the above disclosure, the circulation efficiency can be improved in the liquid ejection head having a configuration to circulate liquid using an energy generating element.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-157588, filed on September 11, 2024, which is hereby incorporated by reference herein in its entirety.

What is claimed is:

1. A liquid ejection head comprising:
a liquid ejection portion which includes a pressure chamber, an ejection nozzle for ejecting liquid from the pressure chamber, and an energy generating element that generates energy to eject liquid inside the pressure chamber from the ejection nozzle;
a circulation flow passage which includes an inflow port to which liquid to be supplied to the pressure chamber flows in, and an outflow port from which liquid collected from the pressure chamber flows out, with the pressure chamber being disposed between the inflow port and the outflow port,
a first thermoelectric conversion element which is disposed on the circulation flow passage on a side closer to the inflow port than the energy generating element; and
a second thermoelectric conversion element which is disposed on the circulation flow passage on a side closer to the inflow port than the energy generating element, and which is disposed adjacent to the first thermoelectric conversion element, wherein
the first thermoelectric conversion element and the second thermoelectric conversion element are driven at timings different from each other.

2. The liquid ejection head according to claim 1, further comprising a third thermoelectric conversion element which is disposed on the circulation flow passage on a side closer to the inflow port than the energy generating element, and which is disposed adjacent to the first thermoelectric conversion element on an opposite side to the second thermoelectric conversion element,
wherein the first thermoelectric conversion element, the second thermoelectric conversion element and the third thermoelectric conversion element are driven at mutually different timings.

3. The liquid ejection head according to claim 1,
wherein the thermoelectric conversion element is an energy generating element which generates energy to flow liquid inside the circulation flow passage.

4. The liquid ejection head according to claim 1, wherein on the circulation flow passage, a first flow resistance R1 between the inflow port and the thermoelectric conversion element, and a second flow resistance R2 between the outflow port and the thermoelectric conversion element are different.

5. The liquid ejection head according to claim 1,
wherein the ejection nozzle is open in a first direction,
wherein the inflow port and the outflow port are both located on one side of the liquid ejection portion in a second direction which crosses with the first direction, and are disposed in a line in a third direction which crosses with both the first direction and the second direction,
wherein the circulation flow passage includes:
an upstream side flow passage which extends from one side to the other side, in the second direction from the inflow port; and
a downstream side flow passage, which extends from the other side to one side in the second direction, by turning the direction thereof to an opposite direction from the upstream side flow passage,
wherein the thermoelectric conversion element is disposed on the upstream side flow passage, and
wherein the liquid ejection portion is disposed on the downstream side flow passage.

6. The liquid ejection head according to claim 5, further comprising a common flow passage which communicates with each of the inflow port and the outflow port,
wherein the liquid ejection portion is disposed at a plurality of positions so as to align in the third direction,
wherein the upstream side flow passage extends among the plurality of liquid ejection portions in the second direction, so as to cross a row of the plurality of liquid ejection portions, and
wherein the common flow passage is disposed on one side of the inflow port and the outflow port in the second direction, as to extend in the third direction, and communicates with each of the plurality of inflow ports and the plurality of outflow ports, which are disposed corresponding to the plurality of liquid ejection portions.

7. The liquid ejection head according to claim 6, wherein the plurality of energy generating elements disposed corresponding to the plurality of liquid ejection portions, and the plurality of first thermoelectric conversion elements disposed corresponding to the plurality of liquid ejection portions are disposed alternately so as to align in the third direction.

8. The liquid ejection head according to claim 6, further comprising:
a substrate in which the liquid ejection portion, the circulation flow passage and the thermoelectric conversion element are disposed on a first surface side;
a flow passage forming member which is layered on the first surface of the substrate and which includes a partition wall constituting a part of the circulation flow passage; and
an orifice plate in which the ejection nozzle is disposed and which is layered on the flow passage forming member on the opposite side to the substrate,
wherein the pressure chamber and the circulation flow passage are defined by the first surface of the substrate, the partition wall and the orifice plate.

9. The liquid ejection head according to claim 8, wherein the first thermoelectric conversion element and the second thermoelectric conversion element are disposed adjacent to each other in the second direction at different positions from that of the energy generating element in the third direction,
wherein the partition wall includes:
a first partition wall portion extending in the second direction to demarcate the plurality of circulation flow passages corresponding to the plurality of liquid ejection portions in the third direction; and
a second partition wall portion extending in the second direction to demarcate, in the third direction, the energy generating element, the first thermoelectric conversion element and the second thermoelectric conversion element on the individual circulation flow passages,
wherein a side face on one side of the second partition wall portion in the third direction constitutes a part of the upstream side flow passage, and
wherein a side face on the other side of the second partition wall portion in the third direction constitutes a part of the downstream side flow passage and the pressure chamber.

10. The liquid ejection head according to claim 8, wherein the substrate includes a through hole which is on further toward one side than the inflow port and the outflow port in the second direction, and which penetrates between the first surface of the substrate and the second surface which is a rear surface of the first surface, in the first direction, and
wherein the common flow passage is defined by the through hole, the flow passage forming member, and the orifice plate.

11. The liquid ejection head according to claim 1, wherein the ejection nozzle opens in a first direction,
wherein the inflow port and the outflow port are disposed in a line in the first direction, are both located on one side of the liquid ejection portion in a second direction which crosses the first direction,
wherein the circulation flow passage includes:
an upstream side flow passage, which extends from one side to the other side in the second direction from the inflow port; and
a downstream side flow passage, which extends from the other side to one side in the second direction by turning the direction thereof to an opposite direction from the upstream side flow passage,
wherein the thermoelectric conversion element is disposed on the upstream side flow passage, and
wherein the liquid ejection portion is disposed on the downstream side flow passage.

12. The liquid ejection head according to claim 11, wherein the liquid ejection portion and the thermoelectric conversion element are disposed at different positions in the first direction.

13. The liquid ejection head according to claim 12, further comprising a common flow passage which communicates with each of the inflow port and the outflow port,
wherein the liquid ejection portion is disposed at a plurality of positions so as to align in a third direction which crosses with both the first direction and the second direction,
wherein each of the upstream side flow passage and the downstream side flow passage extends in the second direction, and are disposed in a line in the first direction, and
wherein the common flow passage is disposed on further toward one side than the inflow port and the outflow port in the second direction, so as to extend in the third direction, and communicates with each of the plurality of inflow ports and the plurality of outflow ports, which are disposed corresponding to the plurality of liquid ejection portions.

14. The liquid ejection head according to claim 13, wherein the plurality of circulation flow passages disposed corresponding to the plurality of liquid ejection portions are disposed to align in the third direction,
wherein the plurality of energy generating elements disposed corresponding to the plurality of liquid ejection portions are disposed to align in the third direction,
wherein the plurality of first thermoelectric conversion elements disposed corresponding to the plurality of liquid ejection portions are disposed to align in the third direction, and
wherein the plurality of second thermoelectric conversion elements disposed corresponding to the plurality of liquid ejection portions are disposed to align in the third direction.

15. The liquid ejection head according to claim 13, further comprising:
a first substrate including a first surface, a second surface and a connection hole, the first surface, on which the liquid ejection portion is disposed, constituting a part of the downstream side flow passage and the pressure chamber, the second surface, which is a rear surface of the first surface, constituting a part of the upstream side flow passage, and the connection hole, which penetrates between the first surface and the second surface in the first direction, constituting a connection flow passage that connects the upstream side flow passage and the downstream side flow passage on the circulation flow passage;
a first flow passage forming member, which is layered on the first surface of the first substrate, and constituting a part of the downstream side flow passage and the pressure chamber;
an orifice plate, on which the ejection nozzle is disposed, the orifice plate being layered on the first flow passage forming member on the opposite side to the first substrate, and constituting a part of the downstream side flow passage and the pressure chamber;
a second flow passage forming member, which is layered on the second surface of the first substrate, and constituting a part of the upstream side flow passage;
a second substrate which is layered on the second flow passage forming member on the opposite side to the first substrate, the second substrate having the first thermoelectric conversion element and the second thermoelectric conversion element that are disposed on a side facing the second flow passage forming member, and constituting a part of the upstream side flow passage; and
a common hole which is disposed on further toward one side than the inflow port and the outflow port in the second direction, the common hole sequentially penetrating the first flow passage forming member, the first substrate, the second flow passage forming member and the second substrate in the first direction, and constituting the common flow passage.

16. The liquid ejection head according to claim 1,
wherein the ejection nozzle opens in a first direction
wherein the inflow port is located on one side of the pressure chamber in a second direction which crosses the first direction,
wherein the outflow port is located on the other side of the pressure chamber in the second direction
wherein the circulation flow passage extends in the second direction, so that the inflow port, the pressure chamber and the outflow port are sequentially aligned in the second direction, and
wherein the thermoelectric conversion element is disposed on the circulation flow passage on a side closer to the inflow port than the energy generating element.

17. The liquid ejection head according to claim 16, further comprising a common flow passage which communicates with each of the inflow port and the outflow port,
wherein the liquid ejection portion is disposed at a plurality of positions so as to align in a third direction which crosses with both the first direction and the second direction, and
wherein the common flow passage communicates with each of the plurality of inflow ports and the plurality of outflow ports, which are disposed corresponding to the plurality of liquid ejection portions.

18. The liquid ejection head according to claim 17,
wherein the plurality of circulation flow passages disposed corresponding to the plurality of liquid ejection portions are disposed to align in the third direction,
wherein the plurality of energy generating elements disposed corresponding to the plurality of liquid ejection portions are disposed to align in the third direction,
wherein the plurality of first thermoelectric conversion elements disposed corresponding to the plurality of liquid ejection portions are disposed to align in the third direction, and
wherein the plurality of second thermoelectric conversion elements disposed corresponding to the plurality of liquid ejection portions are disposed to align in the third direction.

19. The liquid ejection head according to claim 17, further comprising a substrate in which the liquid ejection portion, the circulation flow passage and the thermoelectric conversion element are disposed on the first surface side,
wherein the substrate includes:
a supply side through flow passage, which penetrates the substrate in the first direction, between the first surface and a second surface which is a rear surface of the first surface, on further toward one side than the inflow port in the second direction; and
a discharge side through flow passage, which penetrates the substrate in the first direction, between the first surface and the second surface, on further toward the other side than the outflow port in the second direction, and
wherein the common flow passage is formed to communicate with each of the supply side through flow passage and the discharge side through flow passage on the side of the second surface of the substrate.

20. A liquid ejection apparatus comprising:
a liquid ejection head; and
a control portion which controls driving of the thermoelectric conversion elements;
wherein the liquid ejection head includes:
a liquid ejection portion which includes a pressure chamber, an ejection nozzle for ejecting liquid from the pressure chamber, and an energy generating element that generates energy to eject liquid inside the pressure chamber from the ejection nozzle;
a circulation flow passage which includes an inflow port to which liquid to be supplied to the pressure chamber flows in, and an outflow port from which liquid collected from the pressure chamber flows out, with the pressure chamber being disposed between the inflow port and the outflow port,
a first thermoelectric conversion element which is disposed on the circulation flow passage on a side closer to the inflow port than the energy generating element; and
a second thermoelectric conversion element which is disposed on the circulation flow passage on a side closer to the inflow port than the energy generating element, and which is disposed adjacent to the first thermoelectric conversion element, wherein
the first thermoelectric conversion element and the second thermoelectric conversion element are driven at timings different from each other.
